(19) United States
(12) Patent Application Publication
(10) Pub. No.: US 2009/0039145 A1
(43) Pub. Date: Feb. 12, 2009

(54) STOCK PRODDER

(76) Inventor: Per Ib Rosendal Andersen, Pukekohe (NZ)

Correspondence Address: OCCHIUTI ROHLICEK & TSAO, LLP, 10 FAWCETT STREET, CAMBRIDGE, MA, 02138, US

(21) Appl. No.: 12/186,669

(22) Filed: Aug. 6, 2008

(30) Foreign Application Priority Data
Aug. 7, 2007 (NZ) 560460

(51) Int. Cl. F41B 15/04; H01F 38/00

(52) U.S. Cl. 231/7; 323/355

(57) ABSTRACT

The invention provides a power module for a stock prodder and a stock prodder including the power module. The power module includes an input section coupleable to a power source, an output section operatively coupled to the input section and configured to output power to discharge electrodes of a stock prodder, and a control circuit. In use, the control circuit is configured to automatically vary the output power, preferably by increasing the output power.

### FIELD OF THE INVENTION

The present invention relates generally to animal management and control. More particularly, the invention relates to an electrical discharge prodder, preferably handheld, that coerces animals to move. The invention also provides a power module therefor.

### BACKGROUND

Devices that provide an electric shock to control behaviour or movement of animals are well known. These devices are known as electric fence controllers and stock or cattle prodders. Cattle prodders are available in a variety of shapes and sizes and can be characterized in that they are able to control animals using high voltage electrical discharges. Generally, stock prodders are hand held devices that comprise a housing that contains a power source, circuitry used to generate a high voltage, and a pair of high voltage electrodes. The stock prodder's power source is typically a dry-cell battery or rechargeable battery that is connected to an input of the circuitry used to generate the high voltage, with the high voltage being generated by a step up transformer and/or a capacitor multiplier circuit. The high voltage output generated by the circuitry is typically connected to a pair of electrodes, which extend away from the exterior of the housing. The electrodes are spaced apart from each other by a distance that is sufficient to prevent discharge between the electrodes. In use, the prodder is activated to generate a high voltage at the electrodes and the tips of the electrodes are brought into contact with, or in close proximity to, the skin of an animal. As the tips of the electrodes near or touch the animal's skin, the prodder discharges leaving the animal with a violent or gentle reminder, depending on the pain threshold of the animal, that it should move or otherwise modify its behaviour.

Presently, most stock prodders are designed to deliver each discharge as a steady or constant stream of high voltage oscillations or pulses having a predetermined intensity and duration. For example, a discharge may have an intensity of 10,000 volts at a frequency of 2,000 oscillations or pulses per second. Early electric stock prodders were only able to produce one discharge level. However, it soon became apparent that one discharge level was not appropriate for all animals. The problem was that some animals were unaffected by the discharge, whereas others found the intensity of the shock to be too great. As a result, some later stock prodders were provided with a switch to change the shock intensity between two different discharge intensity levels or modes, namely, high and low. Other stock prodders may be provided with interchangeable circuits or electrical generating components that provide predetermined levels of discharge intensity levels that are geared to the particular animal to be controlled. A drawback with these attempts to control the level of discharge intensity is that they are all preset by design and not adjustable. Consequently, such prodders are unable to operate at an optimal level for more than one type of animal.

Other stock prodders are available where the output power may be adjusted using a variable control operated by the operator. Thus, different power levels may be preset by the operator with the animal merely responding to the electric shock at whatever level is set.

Due to this indiscriminate manner of controlling animals, various organizations in different countries (e.g. “Animal Rights” and “Society for Prevention of Cruelty to Animals”-SPCA) have objected to the use and distribution of stock prodders. In some countries, governmental authorities have outlawed the use of stock prodders. Other countries have passed laws stipulating the duration an animal prodder may be used before it ceases to function for a predetermined duration in order to prevent indiscriminate use.

The high voltage potential in present stock prodders can be generated in a number of ways. One way is to use a step-up transformer, which typically comprises a primary (input) winding, a single secondary (output) winding, and an electrically conductive core that is allowed to float (i.e., it is not electrically connected to other components). A drawback of such an arrangement is that electric fields and small amounts of leakage current can cause the core to be charged to an undesirably high voltage potential that can lead to transformer failure. In an alternative configuration, the core may be connected to ground within the circuit, typically via one of the secondary winding connections. A drawback with this arrangement is, relative to the grounded core, the non-grounded end of the secondary winding becomes charged to a voltage that is equivalent to the output of the prodder, which can be around ten thousand volts or higher. This alternative configuration with the grounded core requires the transformer to be constructed with additional space between the grounded core and non-grounded end of the secondary winding to reduce electric fields that would otherwise lead to transformer failure.

The high voltage potential in present stock prodders can also be generated using a capacitor multiplier circuit. Such circuits can be designed in several ways. A common circuit design uses a step-up transformer to drive the capacitor multiplier circuit whereby the transformer provides an increase in voltage over the supply voltage and the capacitor multiplier circuit steps up the transformer's output voltage to a high voltage potential. Although the transformer's voltage is lower than the high voltage potential, the transformer in this design may also suffer from the same electric field and leakage current mentioned previously.

Alternatively, the circuit design may use transistors to drive the circuit. However, without the transformer to provide an increase over the supply voltage, the multiplier circuit requires many more stages resulting in a design that is large and expensive. For this reason, such designs are not common in the industry.

Another problem with inverter circuits used in cattle prodders to increase the voltage is the excessive losses due to transformer saturation. A current method of inversion is to use a cross-section of a transformer that matches the power conversion requirements. This known method involves increasing the magnetic flux in the transformer until it approaches saturation. At this point, the power is removed from the primary circuit to allow the energy stored in the core to be transferred to the output circuit. A drawback of this is the excessive losses occurring during the approach to saturation. This is normally converted into heat and is a loss.

A common problem with the aforementioned high voltage generating configurations is that the high voltage can circumvent isolation between the various components and, under certain conditions, presents a potential hazard to the operator. For instance, the operator may inadvertently become part of the electrical pathway when grabbing onto and holding a prodder housing that is covered with condensation, or by accidentally touching an exposed metallic fastener that is in electrical contact with the power supply or primary circuit of the transformer of the prodder, thereby electrically connecting the user to the stock prodder's power supply or primary circuit. In such not altogether uncommon conditions, should one of the electrode tips be brought into contact with an animal, current can flow out one of the high voltage electrodes, down through the animal, through the soil, up through the operator and back into the prodder, where it is passed from the transformer's primary winding to the secondary winding either through direct connection in the circuit or by arcing from the primary winding to the secondary winding, shocking the operator in the process. For this reason, some present stock prodder enclosures try to provide the user with a layer of insulation to keep the user from becoming electrically connected to the power supply or primary circuit of the transformer.

### SUMMARY OF THE INVENTION

It is an object of the invention to provide a power module for a stock prodder which at least mitigates one or more of the aforementioned problems.

Alternatively, it is an object of the invention to provide a stock prodder which at least mitigates one or more of the aforementioned problems.

Alternatively, it is an object of the invention to provide at least a useful choice.

According to a first aspect of the invention, there is provided a power module for a stock prodder having a pair of discharge electrodes, the power module including:
an input section coupleable to a power source;
an output section coupleable to the input section and operable to provide power to the discharge electrodes; and
a control circuit,
wherein, in use, the control circuit is configured to automatically vary the output power so as to vary the output power level to the discharge electrodes.

Preferably, the control circuit is configured to increase the output power level.

Preferably, the control circuit is configured to increase the output power level in one or more steps. More preferably, between 3 and 40 steps are used to increase the output power level from a predetermined minimum level to a predetermined maximum level.

Preferably, each step in the output power level is of substantially the same magnitude. Alternatively, successive steps may increase and/or decrease in magnitude.

Preferably, the control circuit is configured to transition from the minimum level to the maximum level within a predetermined time period.

Preferably, the predetermined time period ranges from 1 to 10 seconds.

The control circuit may be configured such that each step in power over the predetermined time period takes substantially the same amount of time. Alternatively, the time taken for each power step may vary.

While the aforementioned parameters are preferred, the invention is not limited thereto.

Preferably, the power module includes a transformer coupling the input section to the output section.

Preferably, the input section includes a switch for controlling the transfer of power to the transformer. According to preferred embodiments, the switch is a semi-conductor switch.

Preferably, the input section is configured such that the switch is turned on for a first time period, during which power is transferred to the transformer.

Preferably, the first time period is predetermined.

Preferably, the input section is configured such that after a second, subsequent time period during which the switch is turned off, the switch is turned on again.

Preferably, the second time period is predetermined.

The switch may be configured to repeat the on/off switching, with the first and second time periods remaining the same or varying as desired.

By varying the second time period or the “OFF time”, the output power level may be varied. More particularly, by reducing the duration of the OFF time, the energy delivered to the transformer (and ultimately to the discharge electrodes) is increased within a given time period.

Preferably, the module includes user input means for receiving control selections of a user, such as the minimum and/or maximum output power levels and/or the number of steps and/or the time taken to ramp up from the minimum to the maximum power level and/or the length of time between each stepped increase in power output.

Preferably, the module is configurable to provide a signal to an audible sounder. More preferably, the module is configured to provide a signal whose frequency and/or amplitude is related to that of the output power voltage. More preferably, the frequency and/or amplitude of the sound is substantially proportional to the output power. The user input means may be additionally configured to enable/disable the provision of the signal to the sounder. While audible signals are known in relation to stock prodders, the audible sounder of the present invention is further advantageous in that the amplitude and/or frequency of the sound varies as the power varies, providing an additional incentive for the animal to move as the output power level increases, as well as providing an indication to the operator of the output power level.

According to a second aspect, there is provided a stock prodder including a power module according to the first aspect.

Other features of the stock prodder of the invention will become apparent from the detailed description hereinbelow.

Thus, the invention provides a stock prodder having a circuit which automatically increases the voltage of the electrical discharge provided thereby. Preferably, the circuit is driven by digital technology. The voltage to the output electrodes of the prodder is preferably automatically incrementally adjusted in predetermined steps of voltages and thus energies to allow the prodder to effectively move animals with different tolerance levels to electric shock discomfort. In this manner, the animal receiving the shock effectively determines the point at which they move and terminate the shock, as opposed to the operator. Additionally, the prodder preferably has a feedback audible tone that provides the operator with a cue to the power level. The frequency of the audible cue is preferably directly proportional to the current output power level. This also provides the animal with an audible stimulation to move.

Embodiments of the invention are preferably provided with a programming function whereby the operator may configure operating parameters of the unit. Such parameters may include but are not limited to whether a progressive or stepped power level is used as opposed to a fixed level, high or low power, or continuous or timed out output. A control is preferably provided which isolates the power supply from the output section of the prodder, thus reducing or eliminating shocks to the user.

The power module is preferably removable and has an input section, an output section, and a multi-functional control circuit. The input section of the power module is operatively connected to a suitable power source and the output section of the power module is operatively connected to a pair of discharge electrodes. The power module is preferably provided with a protective shell or housing making it resistant to the ingress of moisture and contamination. The module may be positioned and secured within a prodder housing. This may be by means of a mechanical coupling such as through use of tongues and grooves. The power source may include or be configured to receive one or more batteries. The battery or batteries may be rechargeable. Where rechargeable batteries are used, they may be removable to allow for charging or may be fixedly housed within the prodder with means provided for connecting them to an external power supply to effect charging.

The prodder preferably contains an inverting transformer. The primary impedance of the transformer is preferably known. By limiting the amount of energy fed into the primary of the transformer it is possible to prevent the transformer approaching saturation and thus generating losses. The quantity of energy fed into the transformer is achieved by fixing the duration of the charge up time. In this manner the quantity of energy needed to produce the desired output is considerably reduced.

The abovementioned specific ranges are preferred because they provide a discernible change in the power level over a useful time range. However, different settings (including outside of such ranges) may be used for different types of animals or for differently sized/aged animals. The settings are therefore preferably manually adjustable. As will become clearer in the detailed description, the invention increases the power output by reducing the interval between fixed duration charge up times of an inverting transformer.

High voltage potentials are preferably achieved through the use of a step-up transformer. This transformer is preferably configured so that the potential for accidentally shocking the operator is greatly reduced. This may be achieved by means of a non-metallic core and specific insulation construction. The winding is preferably divided into a plurality, preferably five, separate coils connected in series which reduces the voltage of any one coil to one fifth of the maximum voltage. This reduces the potential difference of any single winding so the insulation rating of the wire used is never exceeded. The routing of the attached wiring reduces the possibility of arcing between the primary circuit and the high voltage output circuit. This combination also reduces the possibility of transformer failure. Another feature of the step-up transformer in its encapsulated state is that it also has an isolation value higher than the output voltage. By increasing the primary to secondary isolation such that the isolation is greater than the output voltage of the prodder, the output voltage is prevented from jumping from the primary to the secondary winding to complete the circuit through an operator. This reduces the possibility of shock to an operator and the circuitry of the prodder.

The audible output is preferably constructed as a voltage to sound output that is dependant on frequency, such that the frequency change is relayed as the module ramps up in power. The frequency is preferably directly tied to the power level and provides a cue level both to the operator and the animal being controlled.

According to preferred embodiments, a series of connection points on the module or external to the prodder enable the operating modes to be altered. Selections may be made between fixed output power or automatic increase, between fixed output power high or fixed output power low, between continuous power or power time out after a predetermined period, between audible ON or audible OFF, between fixed voltage power “Off” and an audible tone “ON”, or any combination of the above.

Preferred embodiments of the invention have the facility to retain control of settings for at least a predetermined deactivated period, even if the power supply is removed or disconnected. In this manner, if the module is configured to disable all outputs (namely, to provide electric shocks) after having been operated continuously for a certain amount of time (or it has been used a particular amount during a certain amount of time in terms of the number of instances of use and/or for how long during the amount of time it has been used), it will prevent the module from being re-activated until the deactivated period has lapsed so as to prevent a user from making potentially indiscriminate and/or abusive use of a prodder.

Further aspects of the invention, which should be considered in all its novel aspects, will become apparent to those skilled in the art upon reading the following description which provides at least one example of a practical application of the invention.

### BRIEF DESCRIPTION OF THE DRAWINGS

One or more embodiments of the invention will be described below by way of example only and without intending to be limiting with reference to the following drawings, in which reference numerals designate like elements throughout and:

FIG. 1 is an isometric view of a prodder according to an embodiment of the invention;

FIGS. 2 & 3 are cross-section and isometric views, respectively, of a transformer arrangement according to an embodiment of the present invention;

FIG. 4 is an isometric view of a portion of the prodder of FIG. 1;

FIGS. 5a & 5b is a schematic diagram of a circuit according to an embodiment of the invention;

FIGS. 6 & 7 are exploded views showing preferred couplings for components according to an embodiment of the invention; and

FIG. 8 is a cross-sectional view of a preferred head arrangement for cattle prod electrodes.

### DETAILED DESCRIPTION OF PREFERRED EMBODIMENTS

Embodiments of the invention make the use of stock prodders more acceptable to animals and the humans who oppose their use, by moving the control of the power level away from the operator and effectively giving this control to the animal. This is achieved by starting the power level at a predetermined low level and increasing the level over a fixed time period, preferably in steps. When the output discharge electrodes are in contact with the animal skin and the power level reaches the discomfort level as felt by the animal itself, the animal will move away from the source of the pain and thus interrupt the source of the pain.

In conjunction with the progressively increasing output power level, an audible sounder may be provided. Preferably, the sound generated thereby increases in frequency and/or volume as the power level is increased at the electrodes. This may have a similar effect as would stinging insects such as wasps or bees that increase the vibrations of their wings upon becoming more agitated, thus raising the frequency of the sound. This increasing frequency sound has an effect on animals as they associate the sound with potential pain.

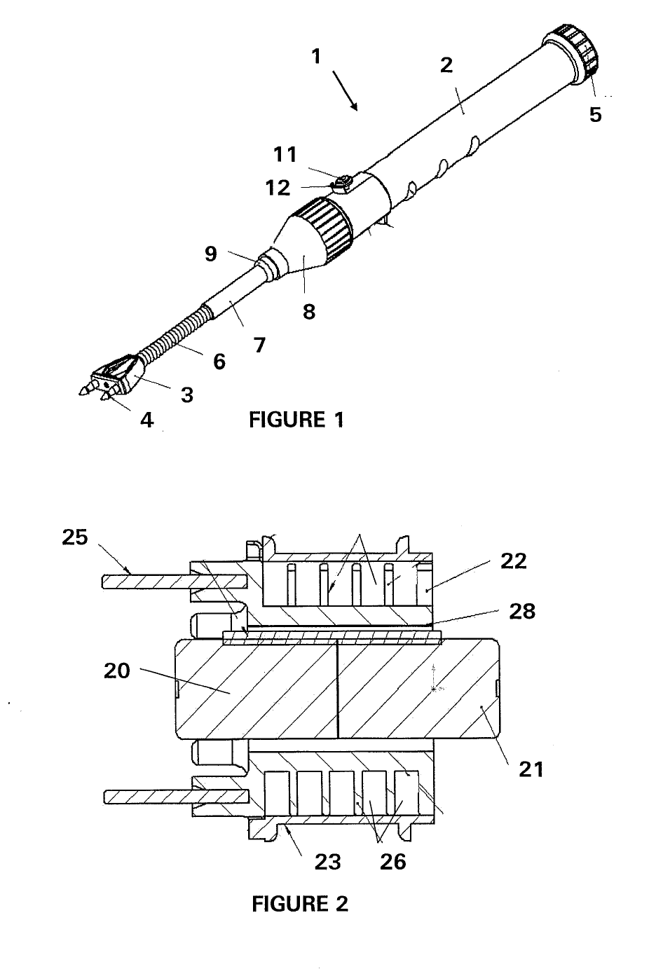

Referring to FIG. 1, a preferred embodiment of a stock prodder 1 is depicted and includes elongated body 2, a head which holds electrical tips/contacts/electrodes 4 at first end 3 of stock prodder 1, and second end 5. According to the embodiment shown in FIG. 1, second end 5 includes a removable cap allowing insertion/removal of batteries. The head used to hold discharge electrodes 4 at first end 3 is preferably formed from moulded plastic and includes connection cover 10.

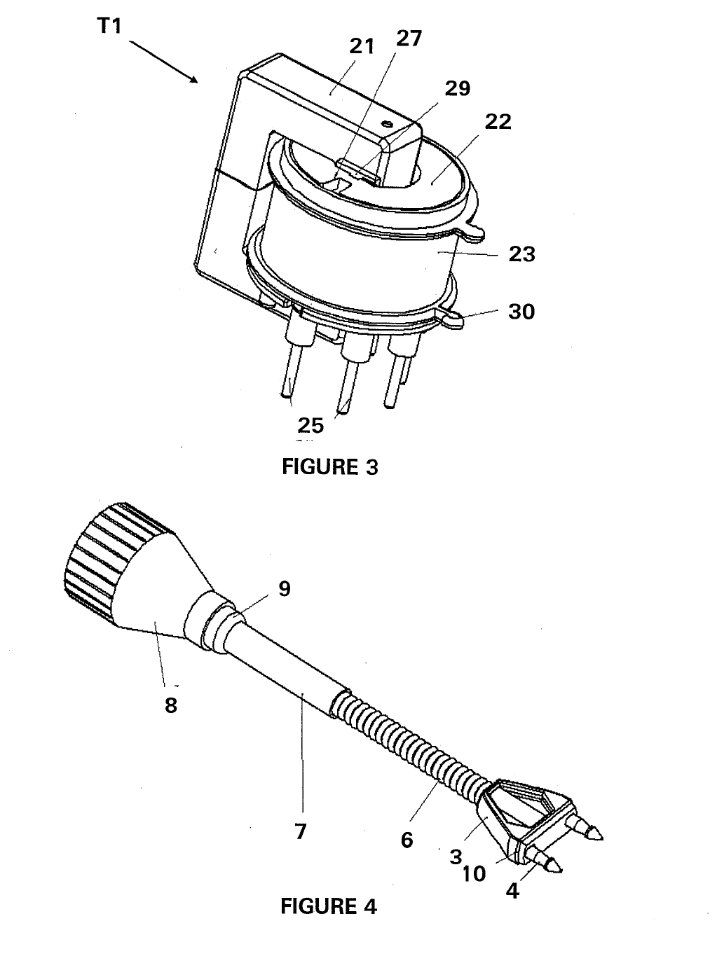

First end 3 is provided at one end of flexible shaft assembly 6 to 9. FIG. 4 provides a clearer representation of flexible shaft assembly 6 to 9, which according to preferred embodiments is detachable. Flexible shaft assembly 6 to 9 includes attachment fitting 8, base 9, sleeve 7 and flexible member 6. Attachment fitting 8, preferably in the form of a tapered collar, enables flexible shaft assembly 6 to 9 to be coupled to body 2, preferably using cooperative threads although other couplings may alternatively be used.

Flexible member 6 preferably consists of a tension wound spring which enables the orientation of first end 3 (more particularly, electrodes 4) to vary when in contact with an animal to help ensure that the contact is not broken. The skilled man will be aware of other flexible means which may be used in place of a tension wound spring and all such alternatives are included within the scope of the invention. Moreover, there is no requirement for discharge electrodes 4 to be flexibly mounted on prodder 1 (i.e., member 6 may be rigid or substantially rigid). Note that high voltage current must be passed to electrodes 4 and elements of flexible shaft 6 are therefore preferably hollow so as to enable housing of wires for conveying said current.

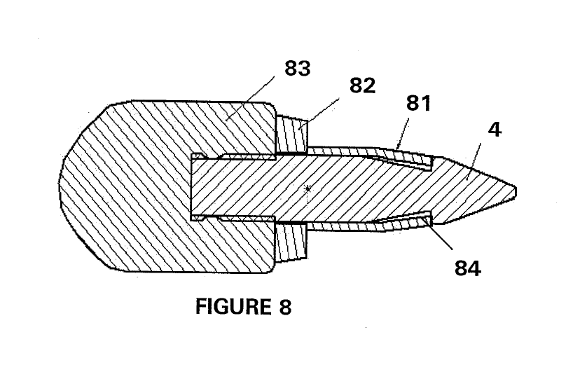

FIGS. 6 and 7 show additional detail of the interface between body 2 and flexible shaft assembly 6 to 9. Sleeve 7 is coupled to prodder 1 by attachment fitting 8 and base 9. Sleeve 7 serves to provide a degree of rigidity to flexible member 6. Referring to FIG. 6, the end of body 2 distal from second end 5 of prodder 1 preferably provides a cavity having slots 60 (see FIG. 7) for housing module 61. Module 61 contains the circuitry required to generate the high voltage current. Switch 11 protrudes into the cavity. Switch 11 preferably includes lock or safety catch 12 to prevent inadvertent operation of prodder 1. Switch 11 activates prodder 1 when depressed by connecting batteries within body 2 to electrodes 4 via negative sleeve 62, a conductive spring within body 2 (not shown) and positive contact 63. Insulating wall 64 is positioned between module 61 and the power supply and acts as an electrical firewall therebetween.

FIG. 8 is a cross-sectional view of a prodder head assembly for provision at first end 3 of prodder 1 according to a preferred embodiment of the invention. Captivating sleeves 81 shroud discharge electrodes 4. Retaining connection cover 82 couples electrodes 4 to housing 83. As shown in FIG. 8, electrodes 4 preferably include recess 84 which allows captivating sleeves 81, preferably in the form of a flexible expandable tubular sleeve, to be pressed over electrodes 4. After captivating sleeves 81 are in place, the top edge thereof is held in recess 84 to prevent damage thereto and insulate the shafts of electrodes 4. Below captivating sleeves 81, bare high voltage wiring directly couples to electrodes 4. This provides a permanent joint between electrodes 4 and the internal high voltage wire so that it is sealed against ingress of moisture.

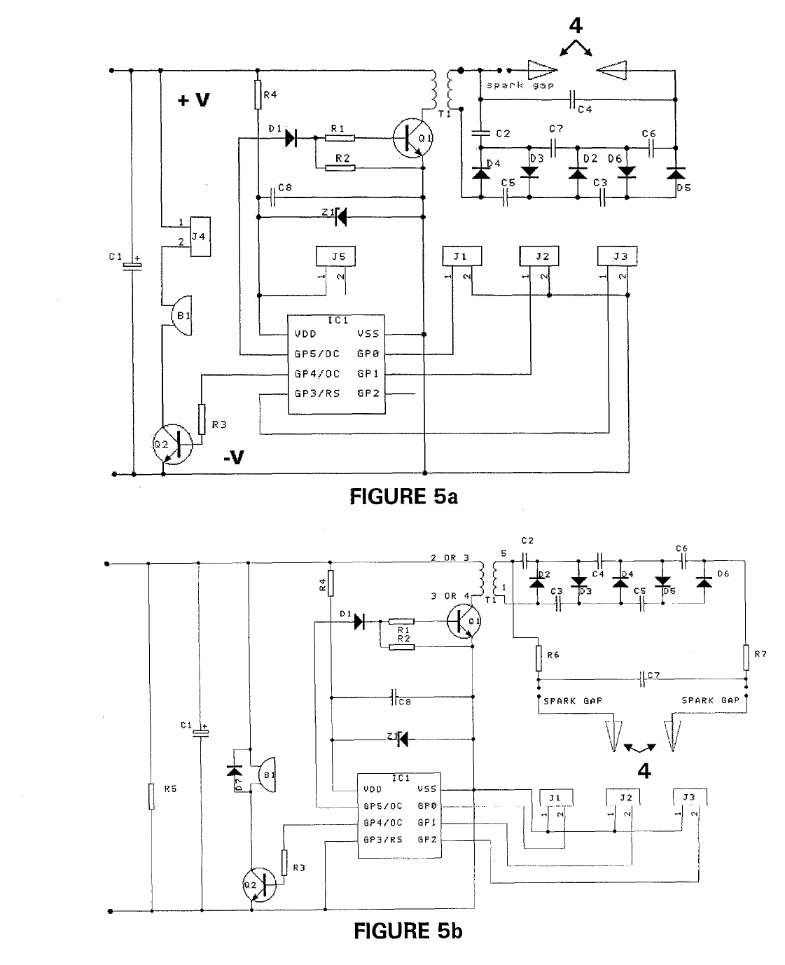

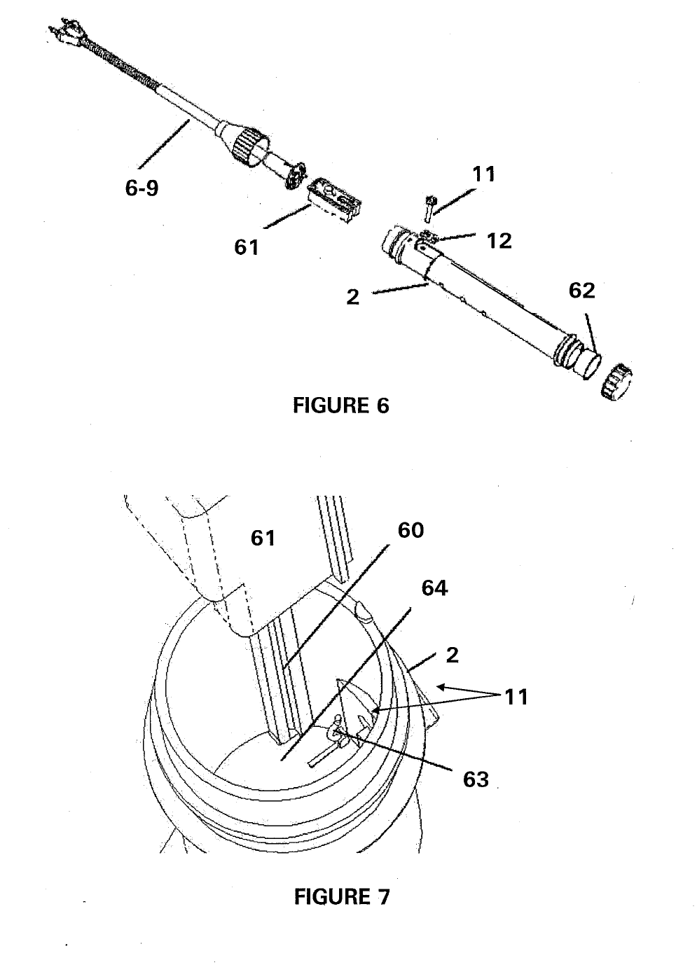

FIG. 5a is a circuit diagram for a preferred embodiment of prodder 1. The power supply is preferably a direct current supply, ranging from 3 V to 9 V. Voltages outside of this range may readily be selected within the scope of the invention. Electrodes 4 are coupled to the power supply via connections provided on module 61. Preferably, separate connections are provided for positive and negative polarities.

Power from the positive polarity is connected to four sections of the circuit. Firstly, to capacitor C1 which acts as an energy storage device and smoothing regulator. Secondly, to the circuit including selection jumper J4, sounder device B1 and semiconductor switch Q2, which circuit enables the sounder to be selected as on or off using jumper J4 and to be driven via resistor R3 by the computer chip IC1. Thirdly, to the circuit including resistor R4, capacitor C8, Zener diode Z1 and computer chip IC1, which circuit effectively forms a regulated power supply for computer chip IC1. Fourthly, the primary of transformer T1, which is in turn connected to semiconductor switch Q1.

Power from the negative polarity is connected to sections of the circuit where the circuit needs to be completed to perform as desired. Three of these connections are provided to program jumpers J1, J2 and J3.

Semiconductor switch Q1 is grounded by resistors R1 and R2. As can be appreciated, semiconductor switch Q1 will always be in a non-conducting state until a voltage appears at the junction of resistors R1 and R2. This voltage is supplied by diode D1. Diode D1 is driven by a voltage from computer chip IC1.

The magnetic flux in transformer core T1 is always zero until semiconductor switch Q1 is switched on. The “On” period of semiconductor switch Q1 determines how much magnetic energy is stored in the magnetic core of transformer T1. By fixing the “On” period to a predetermined duration it is possible to eliminate magnetic core saturation which is important because whenever the core of a transformer saturates, any further energy supplied to the transformer is converted into heat thus resulting in greater losses. As the prodder is preferably powered by a finite power supply, it is desirable to limit any energy loss as this will increase the length of time prodder 1 may be used before recharging or replacing batteries.

Once the magnetic core has been charged with magnetic flux via semiconductor switch Q1, and semiconductor switch Q1 is subsequently turned off, the magnetic flux in transformer T1 proceeds to collapse causing an induced voltage in both the primary and secondary windings of transformer T1. With the configuration of the capacitors C2, C7, C6, C5, C3 and diodes D4, D3, D2, D6 and D5, the energy from the secondary winding of transformer Ti is converted into a high voltage. This high voltage is stored in capacitor C4.

FIG. 5b shows an alternative embodiment circuit arrangement for a prodder. Many of the features of FIG. 5b are similar or the same as those of FIG. 5b and only particular features of significance will be described in relation to FIG. 5b.

In FIG. 5b, the high voltage is stored in capacitor C4 via resistors R6 and R7. The purpose of resistors R6 and R7 is to isolate the stored energy in C7 from the rest of the circuit, thereby reducing feedback noise when the energy is discharged across electrodes 4 These resistors R6 and R7 also reduce the quantity of energy that can be discharged back into the circuit in the event of a failure of insulation associated with the circuit, thereby preserving the integrity of other electronic components in the circuit or elsewhere included in the apparatus.

Referring to FIGS. 5a and 5b, the energy stored for each “On” period of semiconductor switch Q1 is fixed. In order to vary the quantity of energy over time, the “Off” interval between the “On” periods of semiconductor switch Q1 can be varied. In this manner the total stored energy contained in capacitor C4 can be varied. Each “On” period of semiconductor switch Q1 increases the stored energy until the voltage reaches the maximum as determined by the configuration of transformer T1 and the associated voltage increasing circuit as described above.

The spark gap in the circuit is connected in series with the output points (i.e., electrodes 4) and represented by two arrows facing each other in the schematic diagrams of FIGS. 5a and 5b. As the voltage increases in C4 it reaches the potential that is in excess of the voltage break down potential of the spark gap. If the prodder is in contact with an animal's skin at this point in time, a circuit is formed between the spark gap, capacitor C4 and the animal's skin, and the energy stored in capacitor C4 discharges via the spark gap and through the skin of the animal causing stimuli in the animal's skin. The animal reacts to this sensation and normally proceeds to move away from the contact point.

While particular embodiments of circuits have been shown, those skilled in the art will be aware of alternative arrangements which may function similarly. Furthermore, it will be known that certain component(s) may be substituted for one or more other components. Thus, the invention is not limited to the circuits shown in FIGS. 5a and 5b and all such equivalents or alternatives are included within the scope of the invention.

According to the present invention, it is desirable to vary the amount of energy delivered to electrodes 4 on an increasing basis over time, thus allowing the animal to determine the point at which it decides to move. Thus, the energy threshold is now effectively set by the animal on which prodder 1 is used. The minimum threshold of energy over a fixed time period is determined by the breakdown voltage of the spark gap and the quantity of energy as stored in capacitor C4. By reducing the “Off” time of the semiconductor switch Q1 the quantity of energy over time is increased and it is possible to ramp up the energy level delivered to the output electrodes of prodder 1 over a predetermined time period.

Program jumpers J1, J2 and J3 can be used to alter a number of operating parameters of the control circuit by sending instructions to computer chip IC1. For example, one or more of the rate of change of increase, the total duration time of the output, the minimum power level and maximum power level may be altered. Program jumpers J1, J2 and J3 thus provide the operator of the prodder with configurable settings which may be used to tailor the performance of prodder 1 to their own particular preferred operating methods.

FIGS. 2 and 3 provide cross-sectional and isometric views, respectively, of transformer T1. No copper windings are shown to provide increased clarity. Transformer Ti consists of two u-shaped magnetic cores 20 and 21 fitted facing each other. A gap between the two cores provides a decrease in magnetic reluctance allowing a faster increase in magnetic flux during the “On” periods of semiconductor switch Q1. Transformer T1 consists of an inner winding bobbin 22 and an outer winding bobbin 23. Conductive metal pins 25 provide electrical connections for terminating the wires of the windings. These pins may be adapted for a solder type of connection or insulation displacement type of connection. Moreover, the invention is not limited to any particular type of connection. In order to achieve an insulation factor in transformer T1 that is greater than the output voltage, the winding wires are placed at long tracking distances from each other. More particularly, the high voltage windings are placed in five separate compartments 26. The commencement of the high voltage winding is on one of the conductive metal pins 25 and proceeds into the first cavity of series 26, then each subsequent cavity 26 in turn. The winding wire exits the last cavity in slot 27 and passes through gap 28 between spacer 29 and inner bobbin 22. It terminates on the opposite conductive metal pin 25. The second winding is placed on outer bobbin 23. Outer bobbin 23 is positioned over the high voltage winding thus effectively isolating the high voltage winding from the second winding. Lug 30 serves as an anchor point for the second winding before it is connected to the conductive metal pins 25.

A number of elements of the invention are shown as being modular in nature. This enables ready replacement of components in the event of a fault and also for changing the set up of the apparatus. For example, any one of a number of flexible shaft assemblies 6 to 9 may be selected depending on the types of animals to be controlled, as would be apparent to one of skill in the art. However, embodiments of the invention may also be provided in the form of an integrated device, lacking such modularity, but which may provide greater strength and integrity against, for example, the ingress of water.

Where in the foregoing description reference has been made to specific components or integers of the invention having known equivalents, then such equivalents are herein incorporated as individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

1. A power module for providing electrical power to a pair of discharge electrodes of a stock prodder, the power module including:
an input section coupleable to a power source;
an output section operatively coupled to the input section and configured to output power to the discharge electrodes; and
a control circuit,
wherein, in use, the control circuit is configured to automatically vary the output power.

2. The power module of claim 1, wherein the control circuit is configured to vary the output power by increasing the output power.

3. The power module of claim 1, wherein the control circuit is configured to increase the output power in one or more steps.

4. The power module of claim 2, wherein the control circuit is configured to vary the power output between first and second power levels within a predetermined time period.

5. The power module of claim 4, including a transformer coupling the input section to the output section.

6. The power module of claim 5, wherein the input section includes a switch for controlling the transfer of power to the transformer.

7. The power module of claim 6, wherein the input section is configured such that power is transferred to the transformer during a first time period when the switch is turned on.

8. The power module of claim 7, wherein the input section is configured such that no or substantially no power is transferred to the transformer during a second, subsequent time period when the switch is turned off.

9. The power module of claim 8, wherein the input section is configured to repeat said on/off switching so as to transfer a predetermined amount of electrical energy to the transformer.

10. The power module of claim 8, wherein the input section is configured to vary the first and/or second time period so as to control the total amount of electrical energy received during adjacent first and second time periods.

11. The power module of claim 5, wherein the transformer includes a primary coil conductively coupled to the input section and a secondary coil conductively coupled to the output section, wherein the voltage across the secondary coil is high relative to the voltage across the primary coil.

12. The power module of claim 11, wherein the windings of the primary coil at least encircle the windings of the secondary coil.

13. The power module of claim 11, wherein the windings of the secondary coil are divided into a plurality of groups of one or more coils, adjacent coils being connected in series.

14. The power module of claim 13, wherein electrical insulation is provided between adjacent ones of the plurality of groups of one or more coils.

15. The power module of claim 1, including an audible sounder configured to produce sound having a frequency and/or amplitude proportional to that of the output power voltage.

16. A stock prodder for providing an electrical discharge between a pair of discharge electrodes, the stock prodder including a power module according to claim 1.

17. The stock prodder of claim 16, including means for monitoring use of the stock prodder, the means for monitoring being configured to generate a deactivation signal when the monitored use exceeds a predetermined threshold.

18. The stock prodder of claim 17, including means for deactivating the stock prodder, the means for deactivating being communicatively coupled to the means for monitoring, whereby on receipt of the deactivation signal, the means for deactivating is configured to inhibit further use of the stock prodder by preventing electrical discharge between the discharge electrodes.

19. The stock prodder of claim 18, wherein the means for deactivating is configured to deactivate the stock prodder for a predetermined period of time.

20. The stock prodder of claim 19, including memory means communicatively coupled to the means for monitoring and/or the means for deactivating, wherein:
the memory means is configured to store information as to at least one of a time of a deactivation signal and a time remaining of a deactivation period, and
the memory means is configured to retain said information in the event that a primary power source of the stock prodder is disconnected from the power module.
